(19) United States
(12) Patent Application Publication
(10) Pub. No.: US 2023/0016248 A1
(43) Pub. Date: Jan. 19, 2023

(54) MODULAR FACE MASK

(71) Applicant: POLAIR LLC, Glen Allen, VA (US)

(72) Inventors: Jerry ZHANG, Glen Allen, VA (US); Gwyneth ALEXANDER, Putney, VT (US); Saardhak BHRUGUBANDA, Orlando, FL (US); Kaitlyn Grace CALABRESI, New Orleans, LA (US); Zan Zafar CHAUDHRY, Ellicott City, MD (US); Benjamin DUBNER, Wilmington, DE (US); Jason FAN, Akron, OH (US); Eric GUAN, Morganville, NJ (US); Ann JIANG, Santa Monica, CA (US); Elizabeth KIM, Bristow, VA (US); Rachel LI, Brookfield, CT (US); Jonathan LIU, Katy, TX (US); Xingjian LU, Baltimore, MD (US); Shubhan MATHUR, Waxhaw, NC (US); Rebecca Irene MOSIER, Falls Church, VA (US); Kate SAPERSTEIN, Calabasas, CA (US); Abdus Sabour SHAIK, Katy, TX (US); Rahul SWAMINATHAN, Fremont, CA (US); Nina Marie TEDESCHI, East Schodack, NY (US); Kesavan VENKATESH, Plano, TX (US); Eesha VERMA, Northborough, MA (US); Chen Chia WANG, Baltimore, MD (US); Jeremy WANG, Tucson, AZ (US); Daniel ZHANG, Glen Allen, VA (US); Asimina ZOITOU, Athens (GR)

(21) Appl. No.: 17/375,139

(22) Filed: Jul. 14, 2021

(51) Int. Cl. A41D 13/11; A62B 18/02

(52) U.S. Cl. CPC A41D 13/1138; A62B 18/025

(57) ABSTRACT

A modular mask including a first module including a frame having two or more openings, and an attaching mechanism lining one or more edges of the two or more openings; and a second module including: a mask body having a first attaching element allowing the attaching mechanism to temporarily hold the mask body in place completely covering a first opening of the two or more openings, and a filter component having a second attaching element allowing the attaching mechanism to temporarily hold the filter component in place completely covering a second opening of the two or more openings.

### TECHNICAL FIELD

The present disclosure generally relates to a modular face mask. In particular, embodiments of the present disclosure relate to an inventive and unconventional modular face mask with a removable mask body, a removable filter cartridge, and a slim frame which provide users with the ability to quickly change the configuration of the mask for a variety of conditions.

### BACKGROUND

Various conditions necessitate the use of face masks for protection of the wearer and/or other persons in contact with the wearer from respiratory hazards, including, but not limited to, surgical procedures, activities with heavy dust (e.g., sanding), painting, epidemic control/limiting the spread of pathogens, activities requiring the use of aerosol chemicals (e.g., pest control), and smog/air pollution. Most protective face masks could be considered to belong to one of two categories of: medical use masks or industrial/commercial use masks. Medical use masks are designed to catch liquid droplets and aerosolized particles from the wearer's mouth and nose, and to stop bodily fluids and other splashes from reaching the covered portions of the wearer's face.

The second category of masks, industrial/commercial use masks, are designed solely for the protection of the wearer, in contrast with most medical use masks, which have the primary purpose of protecting others (usually the patient). These industrial/commercial use masks are also referred to as respirators. Respirators come in two varieties: full facepiece and half facepiece, where a full facepiece respirator covers the eyes, nose, and mouth, while a half facepiece respirator only covers the nose and mouth. Respirators also seal tightly to the face, in contrast with most medical use masks.

Often, working/living conditions require the ability to switch the type of mask being worn in response to a changing environment. This often requires possessing several separate face masks and swapping entire masks, which can become cumbersome and costly for the user. Consider, for example, the changes observed in the medical environment because of the COVID-19 pandemic, where mask-wearing became mandatory for medical workers. For example, a clear mask may provide advantages to the patient-provider relationship because it facilitates ease of communication; however, medical personnel often require higher efficacy masks for observing more serious patients, such as masks containing N95 grade filters. Thus, the ability to efficiently switch from one mask variety to another represents an important and needed advancement in the design of protective face masks.

### SUMMARY

One aspect of the present disclosure is directed to a modular mask. The modular mask may include a first module including a frame having two or more openings, and an attaching mechanism lining one or more edges of the two or more openings; and a second module including a mask body having a first attaching element allowing the attaching mechanism to temporarily hold the mask body in place completely covering a first opening of the two or more openings, and a filter component having a second attaching element allowing the attaching mechanism to temporarily hold the filter component in place completely covering a second opening of the two or more openings.

Another aspect of the present disclosure is directed to a modular mask. The modular mask may include a first module including a frame having an opening, and an attaching mechanism lining an outer edge of the opening; and a second module including a mask body having an attaching element allowing the attaching mechanism to temporarily hold the mask body in place completely covering the opening, wherein the mask body includes a filter.

Yet another aspect of the present disclosure is directed to a modular mask. The modular mask may include a first module including a frame having two or more openings, and an attaching mechanism lining one or more edges of the two or more openings; and a second module including a mask body able to be temporarily held in place by the attaching mechanism completely covering a first opening of the two or more openings, and a filter component able to be temporarily held in place by the attaching mechanism completely covering a second opening of the two or more openings.

Other modular masks are also discussed herein.

### BRIEF DESCRIPTION OF THE DRAWINGS

FIG. 1 is a front-view depiction of a modular face mask, consistent with the disclosed embodiments.

FIG. 2 is an exploded-view depiction of a modular face mask, consistent with the disclosed embodiments.

FIG. 3 is a side-view depiction of a clear modular face mask, consistent with the disclosed embodiments.

FIG. 4 is a side-view depiction of a filter modular face mask, consistent with the disclosed embodiments.

### DETAILED DESCRIPTION

The following detailed description refers to the accompanying drawings. Wherever possible, the same reference numbers are used in the drawings and the following description to refer to the same or similar parts. While several illustrative embodiments are described herein, modifications, adaptations and other implementations are possible. For example, substitutions, additions, or modifications may be made to the components illustrated in the drawings. Accordingly, the following detailed description is not limited to the disclosed embodiments and examples. Instead, the proper scope of the invention is defined by the appended claims.

Embodiments of the present disclosure may be directed to a modular face mask comprising two or more modules. The disclosed modular face mask may be used in medical environments with medical grade filtration, for smog protection in polluted areas, for industrial protection, such as from dust or paint, or in any other environment which may benefit from the use of the modular face mask as disclosed herein. In certain embodiments, a face mask may refer to an item of protective equipment which may primarily guard the airways such as, for example, a respirator, a surgical mask, a cloth mask, a dust mask, a diving mask, or any other variety of mask which protects one or more of a user's airways. A modular face mask may refer to a face mask which comprises a modular design. For example, a modular face mask may be subdivided into smaller parts (i.e., modules) which may be independently designed, built, modified, replaced, or exchanged with other modules or between different face masks. A user may exchange one face mask module for another to, for example, achieve a different effect in the use of the face mask. It should be noted that mask, face mask, modular mask, and modular face mask may be used interchangeably herein with respect to the disclosed modular face mask, unless otherwise specified.

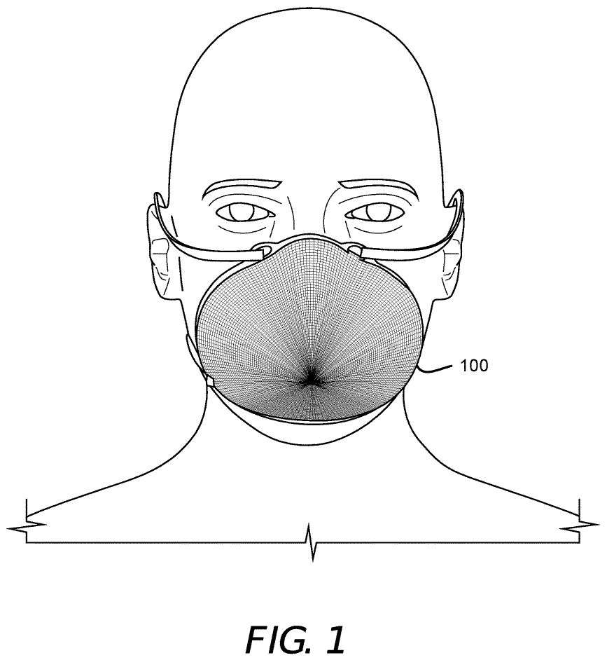

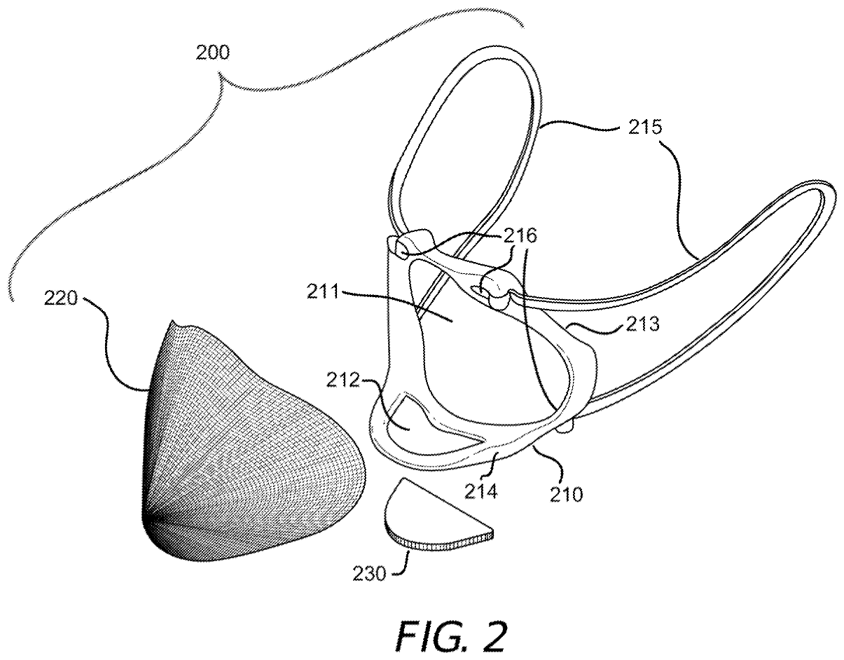

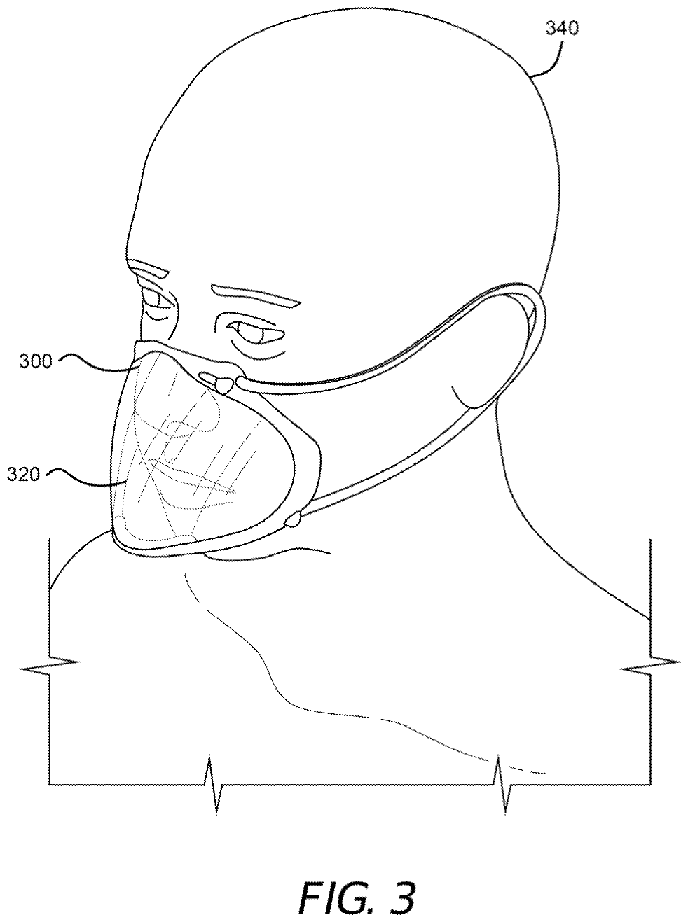

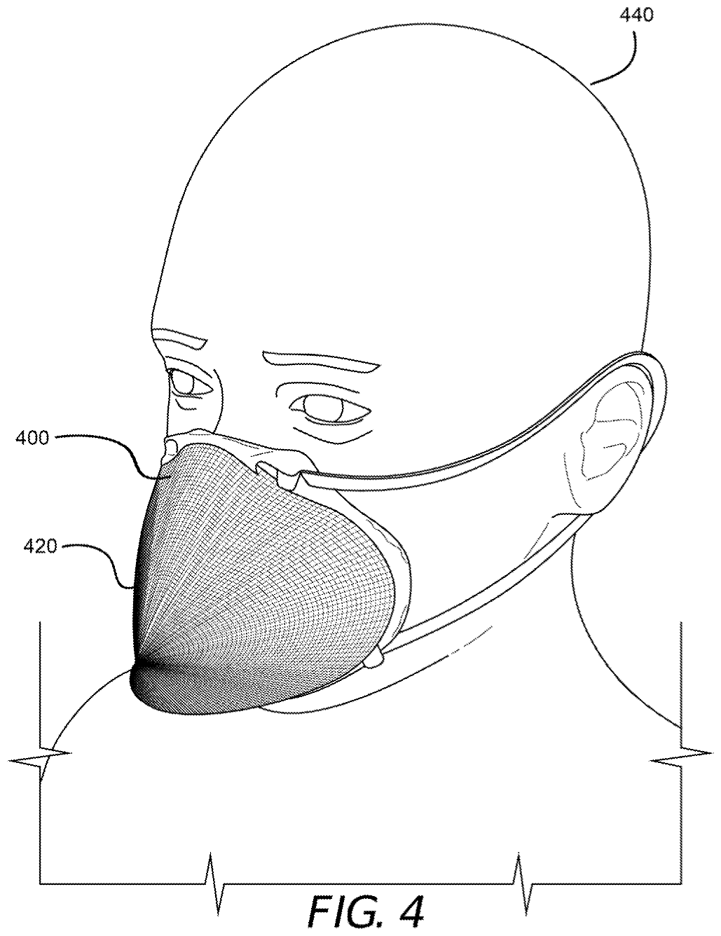

By way of example, the modular face mask may be represented by a front-view of a mask 100 of FIG. 1, an exploded-view a mask 200 of FIG. 2, a side-view of a clear mask 300 of FIG. 3, or a side-view of a filter mask 400 of FIG. 4.

Some disclosed embodiments may involve a first module including a frame having two or more openings. A frame in some instances may refer to an open structure which may be designed for admitting, enclosing, holding, or supporting something. For instance, a frame may be designed to hold a mask body in such a way that the airways of a user or a person standing in the vicinity of a user are protected from respiratory hazards. The mask body will be described in greater detail below. In some embodiments, a backside of the frame may rest partially or completely against the face of a user. In certain embodiments, the frame may be made of a flexible material which may conform to the shape of the face of a user. In other embodiments, the frame may be made of a rigid material. Additionally or alternatively, the frame may include a comfortable member disposed along an inner edge of the frame such that it decreases the pressure felt on a user's face from the frame. For example, the comfortable member may include air-tight foam.

In some embodiments, the disclosed frame may have a width of no more than 0.5 centimeters, 1 centimeter, 2 centimeters, 3 centimeters, or any other width which allows for the mask to be durable yet is not so inappropriately large that it may be inappropriate for its intended use. For example, if a user intends to use the modular face mask in a surgical setting and later in public, wearing a frame with a large width may prove cumbersome and may even be inappropriate as it may impact visibility or hinder communication attempts.

An opening may refer to a void in the frame such as an aperture, gap, or hole. In some embodiments, the frame may have two or more openings to allow one or more modules to be attached to the frame. In some embodiments, the openings may be disposed such that a user's mouth is at least partially visible through the openings. For instance, for a frame having two openings, a first opening may be disposed in front of a user's mouth to accommodate a clear mask body, which would allow the user's mouth to be seen while wearing the mask, and a second opening may be disposed below the first opening in the vicinity of the user's chin to accommodate a filter component, valve, or other appropriate component which would restrict the airflow into or out of the user's airways. The positioning of the second opening may be such that a non-transparent component may be attached to the opening without obstructing a view of the user's mouth.

In certain embodiments, one or more members may be attached to the frame to hold the modular mask in place covering at least a user's mouth and nose. For example, the one or more members may include ear loops which may wrap around the ears of a user. The ear loops may be made of fabric, silicon, plastic, or any other flexible material. The ear loops may be attached to the frame through hollow, semicircular notches disposed on the edge of the frame. The length of each ear loop may be adjusted via a strap adjuster disposed on the ear loop into which the flexible material is fed. A person of ordinary skill in the art would understand that the ear loops may be attached to the frame by any appropriate mechanism.

In some embodiments, the frame may include a lip around or partially surrounding a frontside or sides of the frame, for example, around the openings. The lip may aid in the alignment of the modular components during attachment onto the frame. The lip may consist of a flexible or semiflexible material such that it conforms to the mask body during or after mask body placement onto the frame. As such, the lip may contribute to creating a more secure seal between the mask body and frame. Additionally or alternatively, the lip and/or the frame may include a groove to aid in the attachment of the mask body and to create a tighter seal between the frame and the mask body.

By way of example, FIG. 2 depicts an exploded-view drawing of a mask 200 with a frame 210. Frame 210 may include a first opening 211 and a second opening 212 configured to accept a mask body 220 and a filter component 230, respectively. When a user wears mask 200, first opening 211 may be disposed in front of the user's mouth and nose, and second opening 212 may be disposed near the user's chin, as depicted in FIG. 3. A backside 213 may rest partially or completely against the face of a user. A comfortable member (not shown) may be disposed on backside 213 such that it decreases the pressure felt on a user's face from the frame. A frontside 214 may be configured to accept mask body 220 through first opening 211 and filter component 230 through second opening 212. Frontside 214 may include an attaching mechanism, which will be discussed in greater detail below. Frontside 214 may include a lip (not shown) to aid in the alignment of the modular components during attachment to frame 210 and contribute to creating a more secure seal between frame 210 and mask body 220 and filter component 230. Additionally or alternatively, frame 210 may include a groove (not shown) along first opening 211 and/or second opening 212 to aid in the attachment of the mask body and to create a tighter seal between frame 210 and mask body 220 and filter component 230. Frame 210 may have a narrow width, as shown, for example, so as to not impact visibility or hinder communication attempts. Ear loops 215 may be attached to frame 210 to hold mask 200 in place while being worn by a user, as depicted in FIGS. 1, 3, and 4. Ear loops 215 may be attached to frame 210 through notches 216 disposed on frame 210.

Some disclosed embodiments may involve the first module including an attaching mechanism lining one or more edges of the two or more openings. An attaching mechanism may refer to a structure which mechanically, magnetically, or otherwise affixes two or more objects together. For example, the attaching mechanism may affix a first module including a frame and a second module including a mask body, together. The attaching mechanism may be used to create a non-permanent joint, that is, a joint which may be removed or dismantled without damaging the joining components and which may be temporary in nature. An edge of an opening may refer to the outside limit of the frame which constitutes the opening. The attaching mechanism may be disposed on one or more edges of the two openings in order to affix one or more components to the frame. For example, for an attaching mechanism involving the use of magnets, magnets may be disposed to line an outer edge of a first opening of the frame so that a component including magnets or metals susceptible to magnetism may be attached to the frame. In some embodiments, the attaching mechanism may be disposed on the lip of the frame.

The attaching mechanism may involve the use of magnets, integral fasteners, threaded fasteners, snap fits, tabs, stapling, embossed protrusions, edge seams, hemming, rivets, pins, adhesives, tapes, or any other appropriate non-permanent fastening methods which may create a temporary seal between a mask body and the frame. In some embodiments, the magnets may be made of any ferromagnetic materials which have been magnetized. In certain embodiments, the attaching mechanism may be configured to interact with another attaching mechanism or an attaching element of another module to create a temporary bond. Additionally or alternatively, the attaching mechanism may be configured to hold other components in place without interacting with another attaching mechanism or attaching element of another module. That is, the attaching mechanism may hold the other components in place regardless of whether the other components include an attaching element. In some embodiments, a first opening and a second opening may have different attaching mechanisms. For instance, the first opening may have a magnetic attaching mechanism, and the second opening may have a mechanical attaching mechanism.

For example, an attaching mechanism (not shown) may line the edges of first opening 211 and second opening 212 of FIG. 2 to attach frame 210 to mask body 220 and filter component 230, respectively. The attaching mechanism may be such that a user may be able to attach and detach mask body 220 and filter component 230 with ease. The attaching mechanism may attach mask body 220 and filter component 230 directly or with the aid of an attaching element included in mask body 220 and/or filter component 230.

Some disclosed embodiments may involve a second module including a mask body having a first attaching element allowing the attaching mechanism to temporarily hold the mask body in place completely covering a first opening of the two or more openings. A mask body may refer to a component made of a rigid or semirigid material which may be shaped such that, when attached to the frame, may leave ample room between a user's mouth and the mask body while minimizing face area. The mask body may act as a barrier for the user's airways and may be designed to completely or partially prevent the wearer from inhaling or exhaling small airborne particles and splashes or sprays of bodily fluids. In some embodiments, the mask body may include a transparent plastic or other clear material, such that a user's mouth is visible behind the mask body when wearing the modular face mask. The transparent plastic may be formed using vacuum forming or any other suitable method. In other embodiments, the mask body may include a filter material such that the mask body acts as a filter of inhaled and/or exhaled air. In yet other embodiments, the mask body may include a different material, such as a fabric, cloth, melt-blown polymer, plastic, silicone, metal, or any other material which may act as a barrier for inhaled and/or exhaled particles. The mask body may include an edge made of a different material than the rest of the mask body to aid in the attachment to the frame, the temporary seal, and the sturdiness of the mask body.

An attaching element may refer to a component which may be coupled with the attaching mechanism of the frame to produce a temporary seal between the mask body and the frame. For example, a wire or otherwise magnetic component may be disposed along the edge of the mask body and may interact with a magnetic attaching mechanism in the frame to create a temporary seal between the mask body and the frame and hold the mask body in place while a user wears the modular face mask. Additionally or alternatively, the edge of the mask body may include a protrusion or other similar mechanical attaching element which may connect to the attaching mechanism of the frame to create the temporary seal and hold the mask body in place.

In some embodiments, when the mask body is attached to the frame, the mask body may completely cover an opening of the two or more openings of the frame, usually the opening which would be disposed in front of a user's mouth when the user is wearing the modular face mask.

In some embodiments, the mask body may include a skeleton. A skeleton may refer to an assemblage of wires or a solid piece of a material which may assist in supporting the mask body. In some embodiments, the skeleton may be disposed between the mask body and the frame. The skeleton may be configured to aid the mask body in leaving ample room between a user's mouth and the mask body. In some embodiments, the skeleton may include an edge made of a different material than the rest of the skeleton to aid in the attachment to the frame. In some embodiments, the skeleton may be configured to secure a piece of fabric or similar material so that it is visible through a clear mask body. The piece of fabric or similar material may include a personalization or design that may be modified by a user.

By way of example, FIG. 2 depicts a mask body 220 which may include an attaching element (not shown) to allow an attaching mechanism on first opening 211 of frame 210 to hold mask body 220 in place completely covering first opening 211. FIG. 3 depicts a clear mask body 320 which may be made of a transparent plastic or other clear material, such that a mouth and nose of a user 340 may be visible behind mask body 320 while user 340 is wearing clear mask 300. FIG. 4 depicts a filter mask body 420 which may be made of or include a filter material such that mask body 420 acts as a filter of inhaled and/or exhaled air for user 440. In such embodiments, mask 400 may include only one opening as a second opening for a separate filter component may not be necessary.

Some disclosed embodiments may involve the second module having a filter component having a second attaching element allowing the attaching mechanism to temporarily hold the filter component in place completely covering a second opening of the two or more openings. In other embodiments, the filter component may be a part of a third module. A filter component may refer to a removable filter cartridge configured to secure a filter material within, forcing inhaled and exhaled air to pass through the filter material when assembled. The filter material may be a fibrous or porous material which removes small particulates, such as dust, pollen, mold, and bacteria, from the air. The filter material may include an adsorbent or catalyst such as charcoal to remove odors and gaseous pollutants such as volatile organic compounds or ozone.

In some embodiments, the filter cartridge may be separated into a top piece and a bottom piece. The top and bottom pieces may have a second attaching mechanism which may hold the top and bottom pieces together, with the filter material in between. For example, the bottom piece may have pins protruding upwards to align with respective holes on the top piece and the pins may secure the top and bottom pieces when a force is applied to join them. In other embodiments, the filter component may be entirely made of the filter material. The filter material may be chosen from one or more of naturally cooling filter materials, such as mint or khus, reactive filters for gases, industrial dust protection respirators, or any other material which may be used in air filtration.

In some embodiments, the mask body may include an opening for a filter component. Additionally or alternatively, the filter component may include an H channel, so as to aid in producing a tight seal for filtration efficacy. In certain embodiments, the filter component may be attached to either the frame or the mask body by a mechanical attaching mechanism, for example, an interference fit. In other embodiments, the filter component may include a magnet or ferromagnetic material which allows it to be secured by the frame or mask body. In some embodiments, the filter component may take a semielliptical shape, but a person of ordinary skill in the art would understand that any shape which optimizes airflow through the filter material may be used.

In some embodiments, the second module may include one or more valves. A valve may refer to a device for controlling the passage of fluids or air through an opening of the face mask. For example, the second module may include a one-way air valve for providing easier exhalation. As another example, the second module may include a one-way valve for inserting a straw or drinking tube so a user may enjoy a beverage without having to remove the face mask. In other embodiments, the valve may be a part of a third module.

For example, FIG. 2 depicts a filter component 230 which may include an attaching element (not shown) to allow an attaching mechanism on second opening 212 of frame 210 to hold filter component 230 in place completely covering second opening 212.

Some disclosed embodiments may involve a third module including an electronic component. For example, the third module may include a fan, a speaker, a microphone, one or more sensors, an electric sanitization filter, an LED, a battery, capacitor, photovoltaics, or other means for powering an electronic component, or any other electronic component which may be incorporated into the face mask to improve functionality, comfort, or aesthetics.

A fan may include an apparatus that creates a current of air for cooling or ventilation. A speaker may include a device which changes electrical signals into sounds and may be connected to another device separate from the face mask to receive the electrical signals. A microphone may include a device for converting sound into electrical signals which may then be amplified, transmitted, or recorded. The one or more sensors may refer to a device which responds to a physical stimulus (such as heat, light, sound, pressure, magnetism, or a particular motion) and transmits a resulting impulse (as for measurement or operating a control). For example, the one or more sensors may include sensors for Covid-19 detection, air pollution/air quality, temperature, humidity, CO, CO₂, light level, gas sensing, GPS, acoustic/sound/vibration/frequency, air flow, moisture, proximity, sleep monitoring, respiration rate, and/or any other sensor which may improve the functionality of the face mask. An electric sanitization filter may include any filter or surface element which uses electricity to kill germs. An LED may include a light-emitting diode which may be used for personalization/design, indicating battery level, communication, alerting a user, or any other use which would improve the functionality of any of the aforementioned components.

While illustrative embodiments have been described herein, the scope of any and all embodiments having equivalent elements, modifications, omissions, combinations (e.g., of aspects across various embodiments), adaptations and/or alterations as would be appreciated by those skilled in the art based on the present disclosure. The limitations in the claims are to be interpreted broadly based on the language employed in the claims and not limited to examples described in the present specification or during the prosecution of the application. The examples are to be construed as non-exclusive. It is intended, therefore, that the specification and examples be considered as illustrative only, with a true scope and spirit being indicated by the following claims and their full scope of equivalents.

1. A modular mask comprising:
a first module including:
a rigid frame having two openings configured to temporarily house a removable mask body and a removable filter component, wherein a first opening of the two openings is disposed in front of a user's mouth and a second opening of the two openings is disposed below the first opening in the vicinity of the user's chin,
wherein the rigid frame comprises a comfortable member and at least two notches on the edge of the rigid frame,
wherein the comfortable member is disposed along an inner edge of the rigid frame;
wherein the at least two notches are hollow and semicircular and disposed along an outer edge of the rigid frame; and
an attaching mechanism, lining one or more edges of the two openings, to couple the one or more edges to a first coupler and a second coupler; and
a second module including:
the removable mask body having the first coupler configured to temporarily couple to the attaching mechanism such that the mask body completely covers the first opening when the first coupler is coupled to the attaching mechanism, and
the removable filter component having the second coupler configured to temporarily couple to the attaching mechanism such that the filter component completely covers the second opening when the second coupler is coupled to the attaching mechanism.

2. The modular mask of claim 1, the first module further including ear loops, attached to the frame, for looping around the user's ears, to hold the modular mask in place covering the user's mouth and nose.

3. The modular mask of claim 1, wherein the attaching mechanism includes magnets.

4. The modular mask of claim 1, the comfortable member comprises a flexible material, conformable to a shape of the user's face, configured to decrease a pressure felt from the frame on the user's face.

5. The modular mask of claim 1, wherein the frame has a width no greater than 1 centimeter.

6. The modular mask of claim 1, wherein the filter component includes a top piece and a bottom piece configured to hold filter material therebetween.

7. The modular mask of claim 1, wherein the filter component is configured to hold a filter such that air breathed and exhaled by the user using the modular mask passes through the filter.

8. The modular mask of claim 1, wherein the mask body is made of a clear material.

9. The modular mask of claim 8, wherein the first opening is disposed such that the user's mouth is at least partially visible through the mask body and the second opening is disposed such that the filter component does not obstruct a view of the mouth.

10. A modular mask comprising:
a first module including:
a rigid frame having an opening configured to temporarily house a removable mask body, wherein the opening is disposed in front of a user's mouth;
wherein the rigid frame comprises a comfortable member and at least two notches on the edge of the rigid frame,
wherein the comfortable member is disposed along an inner edge of the rigid frame;
wherein the at least two notches are hollow and semicircular and disposed along an outer edge of the rigid frame; and
an attaching mechanism, lining the outer edge of the opening, to couple the outer edge of the opening to a coupler; and
a second module including:
the removable mask body having the coupler configured to temporarily couple to the attaching mechanism such that the mask body completely covers the opening when the coupler is coupled to the attaching mechanism, wherein the mask body includes a filter.

11. The modular mask of claim 10, the first module further including ear loops, attached to the frame, for looping around the user's ears, to hold the modular mask in place covering the user's mouth and nose.

12. The modular mask of claim 10, wherein the attaching mechanism includes magnets.

13. The modular mask of claim 10, wherein the frame has a width no greater than 1 centimeter.

14. A modular mask comprising:
a first module including:
a rigid frame having two openings configured to temporarily house a removable mask body and a removable filter component, wherein a first opening of the two openings is disposed in front of a user's mouth and a second opening of the two openings is disposed below the first opening in the vicinity of the user's chin;
wherein the rigid frame comprises a comfortable member and at least two notches on the edge of the rigid frame,
wherein the comfortable member is disposed along an inner edge of the rigid frame;
wherein the at least two notches are hollow and semicircular and disposed along an outer edge of the rigid frame; and
an attaching mechanism, lining one or more edges of the two openings, to couple the one or more edges to the removable mask body and the removable filter component; and
a second module including:
the removable mask body configured to be temporarily held in place by the attaching mechanism such that the mask body completely covers the first opening when held in place by the attaching mechanism, and
the removable filter component configured to be temporarily held in place by the attaching mechanism such that the filter component completely covers the second opening when held in place by the attaching mechanism.

15. The modular mask of claim 14, the first module further including one or more straps attached to the frame configured to hold the modular mask in place covering the user's mouth and nose.

16. The modular mask of claim 14, wherein the frame has a width no greater than 1 centimeter.

17. The modular mask of claim 14, wherein the filter component includes a top piece and a bottom piece, and wherein at least one of the top piece and the bottom piece includes a second attaching mechanism configured to hold the top piece and the bottom piece together.

18. The modular mask of claim 14, wherein the filter component is configured to hold a filter such that air breathed and exhaled by the user using the modular mask passes through the filter.

19. The modular mask of claim 14, wherein the mask body is made of a clear material.

20. The modular mask of claim 19, wherein the first opening is disposed such that the user's mouth is at least partially visible through the mask body and the second opening is disposed such that the filter component does not obstruct a view of the mouth.
